(19) United States
(12) Patent Application Publication
(10) Pub. No.: US 2006/0059997 A1
(43) Pub. Date: Mar. 23, 2006

(54) Input/output wires for tactile sensor using tri-axial force sensors

(76) Inventors: Jong-Ho Kim, Seo-gu (KR); Dae-Im Kang, Yuseong-gu (KR); Yon-Kyu Park, Yuseong-gu (KR); Min-Seok Kim, Seo-gu (KR)

Correspondence Address: CANTOR COLBURN, LLP, 55 GRIFFIN ROAD SOUTH, BLOOMFIELD, CT, 06002, US

(21) Appl. No.: 11/219,568

(22) Filed: Sep. 2, 2005

(30) Foreign Application Priority Data
Sep. 2, 2004 (KR) 2004-70033

(51) Int. Cl. G01N 3/08

(52) U.S. Cl. 73/818

(57) ABSTRACT

Disclosed is a wiring structure for a tactile sensor, comprising, a substrate and n² tactile sensor units formed on the substrate and arranged in an n×n matrix, whereby the tactile sensor senses a contact force with an external object based on a tactile signal provided from each of the tactile sensor units. Each tactile sensor unit is a tri-axial force sensor with first to fourth piezo-resistors placed in the four directions of upper, lower, left and right sides, to sense a contact force with respect to X and Y axes in parallel with the substrate and the Z axis perpendicular to the substrate, and the tactile sensor includes a total of 4n input/output wires that have 2n input lines connected to one side of the piezo-resistors and 2n output lines coupled with the other ends of the piezo-resistors.

### BACKGROUND OF THE INVENTION

This U.S. non-provisional patent application claims priority under 35 U.S.C. § 119 of Korean Patent Application 2004-70033 filed on Sep. 2, 2004, the entire contents of which are hereby incorporated by reference.

1. Field of the Invention

The present invention is directed to input/output wires for a tactile sensor, and more particularly, to a wiring structure enabling high integration of input/output wires that are utilized to sense information of a contact force with an external object along the X, Y and Z axes.

2. Description of Related Art

The tactile function of acquiring information from the ambient environment by contact, e.g., contact force, vibration, surface roughness, temperature variation by thermal conduction, etc., is currently recognized as the next generation in information acquisition systems. A biomimetic tactile sensor is one means of accomplishing such a tactile function. The importance of the biomimetic tactile sensor has been increased since it can be used in various medical diagnoses and operations such as microsurgery inside blood vessels, cancer diagnosis, and the like, and can also be applied to tactile presentation technology important for future development of virtual reality technologies.

Development of such biomimetic tactile sensor has already been commenced and continues to progress, wherein the sensor is provided with the capability to sense a contact force and instantaneous slide for a force/torque sensor with six degrees of freedom used in an industrial robot's wrist and gripper of the robot.

FIG. 1 shows a tactile sensor unit P, i.e., a tri-axial force sensor, fabricated in the form of a Micro Electro Mechanical System (MEMS) on a wafer S, which is composed of a quadrangular thin-film type contact force sensor that detects loads with respect to three directions, Fx, Fy, Fz. This tactile sensor unit comprises a force sensor, i.e., loading block 1, and a support block 2 supporting the entire structure. In this arrangement, the tactile sensor unit is configured to adhere an overload protection block 3 in the form of a silicon MEMS to the loading block 1 in order to prevent destruction of the film when overload is applied. In the meantime, arranged on one side of the loading block 1 is a piezo-resistor 4 that serves to measure a contact force with an external object using variation in resistance depending upon load applied to the loading block 1.

FIG. 2 is a plan diagram of a tactile sensor composed of four MEMS tactile sensor units, in which four piezo-resistors are placed in the directions of upper, lower, left, and right sides of the loading block 1 in each tactile sensor unit P.

FIG. 3 shows a wiring diagram of input/output circuit for the tactile sensor of FIG. 2. As shown, one tactile sensor unit P needs 8 input/output wires; and, therefore, a total of 32 wires have to be arranged. As such, in case that the number of force sensor units is small, no problem exists for arrangement of input/output wires, but if needed, hundreds of tactile sensor units may need to be integrated. To integrate hundreds of tactile sensor units on a single wafer, however, more than one thousand wires are necessary, resulting in a considerable difficulty in realizing high integration.

### SUMMARY OF THE INVENTION

To solve the problems of the prior art as mentioned above, the present invention improves the degree of integration by more efficiently arranging input/output wires coupled with each tactile sensor unit.

In accordance with an aspect of the present invention, there is provided a tactile sensor, comprising: a substrate; and n² tactile sensor units formed on the substrate and arranged in an n×n matrix, whereby the tactile sensor senses a contact force with an external object based on a tactile signal provided from each of the tactile sensor units, and wherein said each of the tactile sensor units is a tri-axial force sensor with first to fourth piezo-resistors placed in the four directions of upper, lower, left and right sides, to sense a contact force with respect to the X, Y axes in parallel with the substrate and the Z axis perpendicular to the substrate, the tactile sensor including a total of 4n input/output wires that have 2n input lines connected to one side of the piezo-resistors and 2n output lines coupled with the other ends of the piezo-resistors.

Further, the tactile sensor units arranged in n columns are divided into two parts, and, among tactile sensor units in the same row, one side of 2n piezo-resistors constituting the divided n/2 number of tactile sensor units is commonly coupled with one input line.

Moreover, the other sides of a first piezo-resistor constituting tactile sensor units in the kth column and a fourth piezo-resistor constituting tactile sensor units the in (n−k+1)th column are connected to one output line, the other sides of a second piezo-resistor constituting tactile sensor units in the kth column and a third piezo-resistor constituting tactile sensor units in the (n−k+1)th column are connected to another output line, the other sides of a third piezo-resistor constituting tactile sensor units in the kth column and a second piezo-resistor constituting tactile sensor units in the (n−k+1)th column are connected to still another output line, and the other sides of a fourth piezo-resistor constituting tactile sensor units in the kth column and a first piezo-resistor constituting tactile sensor units in the (n−k+1)th column are connected to yet another output line, wherein k satisfies the inequality; 1≦k≦n.

For example, if output signals from the first to fourth piezo-resistors are V1, V2, V3 and V4, respectively, a contact force Fx with respect to the right side direction is defined as V2-V4, a contact force Fy with respect to the upper side direction is represented by V1-V3, and a contact force Fz with respect to the direction perpendicular to the substrate is given by V1+V3+V2+V4.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional diagram of a tactile sensor unit using a conventional MEMS;

FIG. 2 is a plan diagram of a tactile sensor having the tactile sensor unit shown in FIG. 1;

FIG. 3 is a wiring diagram of input/output lines of the tactile sensor in FIG. 2;

FIG. 4 is a wiring diagram of a tactile sensor in accordance with the present invention; and

FIG. 5 is a wiring diagram of input/output lines for a tactile sensor unit in accordance with the present invention.

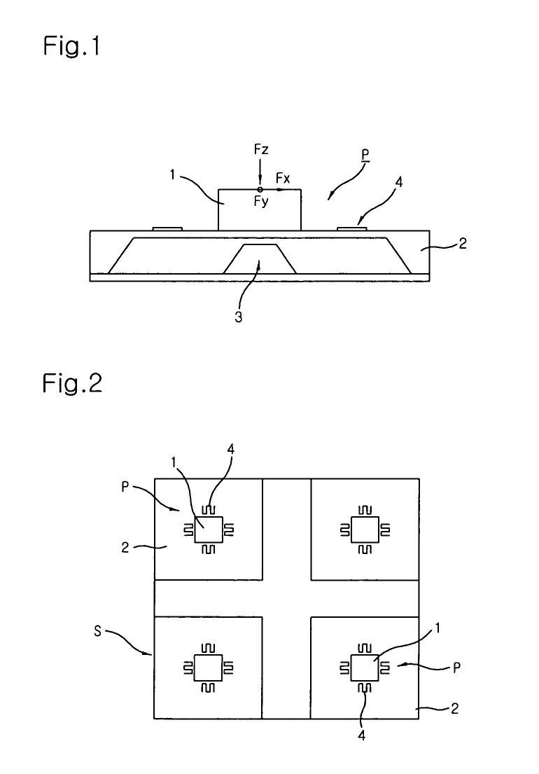

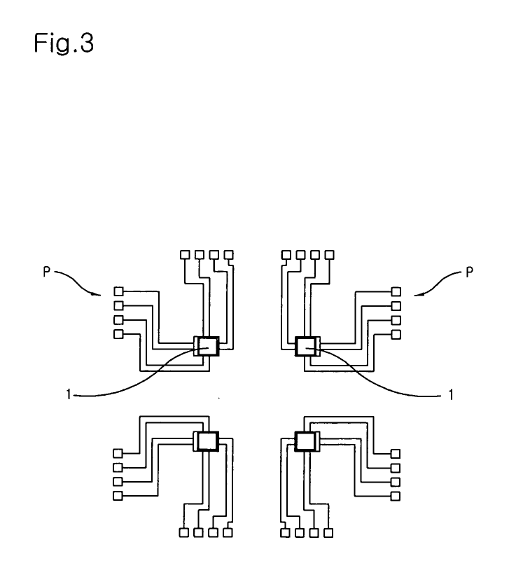

### DETAILED DESCRIPTION OF THE INVENTION

A wiring structure of a tactile sensor of an exemplary embodiment according to the present invention will now be described in detail with reference to the accompanying drawings.

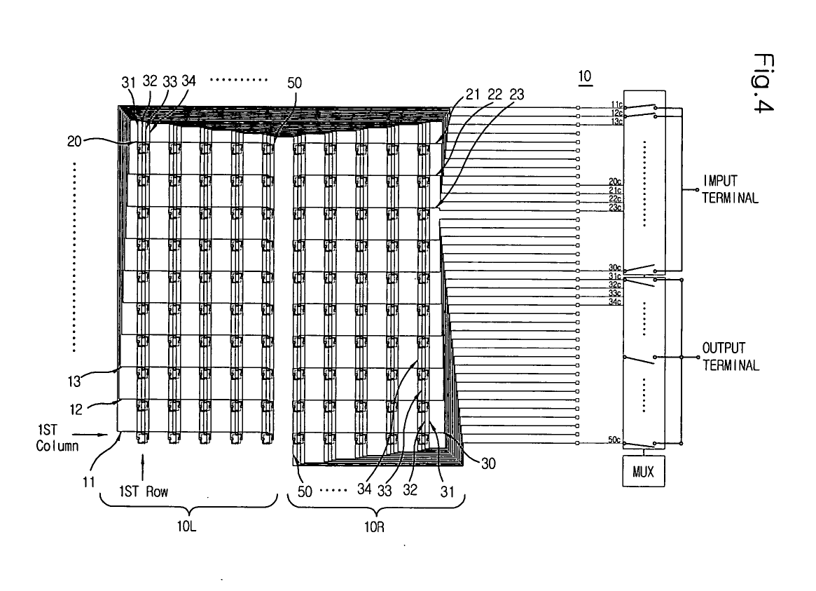

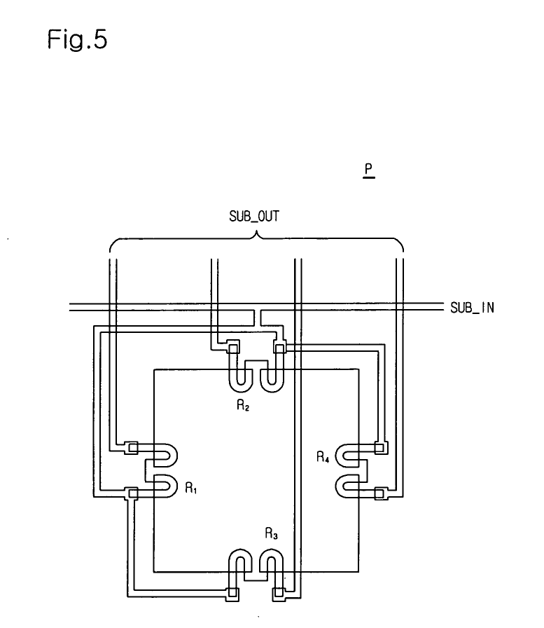

FIG. 4 shows a schematic wiring diagram of a tactile sensor 10 where one hundred tactile sensor units are arranged in a 10×10 matrix in accordance with the present invention, and FIG. 5 illustrates a wiring diagram of input/output lines for one tactile sensor unit P. Firstly, as shown in FIG. 5, one side of a first piezo-resistor R1, a second piezo-resistor R2, a third piezo-resistor R3, and a fourth piezo-resistor R4 that are arranged in each of upper, lower, left and right sides is connected to a single common sub-input line SUB_IN, and the other sides of the four piezo-resistors are coupled with the respective sub-output lines SUB_OUT. With this arrangement, a value of each piezo-resistor can be measured and then a contact force can be sensed based on the measured result, through the input/output lines that are connected to one side and the other side of the piezo-resistors.

Referring back to FIG. 4, the input/output lines that are connected to the tactile sensor units arranged in a 10×10 matrix will now be explained.

The tactile sensor units prepared in ten columns are first divided into five columns 10L of the left side and five columns 10R of the right side. A sub-input line SUB-IN that corresponds to the left columns of the first row is connected to an input line 11 to obtain a common input voltage. Further, a sub-input line with respect to the left columns of the second row is connected to an input line 12, and a sub-input line for the left columns of the tenth row is connected to an input line 20. In this fashion, the sub-input lines for the left columns of the first to tenth rows are coupled with the respective input lines 11 to 20.

In the same manner, a sub-input line with respect to the right columns of the tenth row is connected to an input line 21, and a sub-input line for the right columns of the first row is connected to an input line 30. In this fashion, the sub-input lines for the right columns of the tenth to first rows are coupled with the respective input lines 21 to 30.

According to this configuration, a total of twenty input lines, where two input lines are assigned to each row, are arranged and then connected to respective input terminals 11C to 30C.

Meanwhile, a sub-output line SUB_OUT that is connected to the other side of a first piezo-resistor coupled with a tactile sensor unit of the first column is connected to an output line 31 and also to an output terminal 31C with a sub-output line SUB_OUT that is coupled with the other side of a fourth piezo-resistor connected to a tactile sensor unit of the tenth column. In addition, the other sides of a second piezo-resistor of the first column and a third piezo-resistor of the tenth column are connected to an output terminal 32C via an output line 32, the other sides of a third piezo-resistor of the first column and a second piezo-resistor of the tenth column are connected to an output terminal 33C via an output line 33, and the other sides of a fourth piezo-resistor of the first column and a first piezo-resistor of the tenth column are coupled with an output terminal 34C via an output line 34.

Similarly, the present invention is designed in such a way that the second column is connected to a piezo-resistor of a tactile sensor unit of the ninth column, and the third column to the eighth column, the fourth column to the seventh column, and the fifth column to the sixth column, respectively.

In short, the other sides of the first piezo-resistor constituting the tactile sensor units in the kth column and the fourth piezo-resistor forming the tactile sensor units in the (n−k+1)th column are connected to one output line, the other sides of the second piezo-resistor constituting the tactile sensor units in the kth column and the third piezo-resistor constituting the tactile sensor units in the (n−k+1)th column are connected to another output line, the other sides of the third piezo-resistor constituting the tactile sensor units in the kth column and the second piezo-resistor constituting the tactile sensor units in the (n−k+1)th column are connected to still another output line, and the other sides of the fourth piezo-resistor constituting the tactile sensor units in the kth column and the first piezo-resistor constituting the tactile sensor units in the (n−k+1)th column are connected to yet another output line, wherein k satisfies the inequality; 1≦k≦n.

Accordingly, a total of forty wires including the twenty input lines and the twenty output lines are arranged.

In addition, if it is assumed that the output signals from the four piezo-resistors, i.e., the first to fourth piezo-resistors, arranged in one tactile sensor unit are V1, V2, V3 and V4, respectively, a contact force Fx with respect to the X axis is represented by V2-V4, a contact force Fy with respect to the Y axis is defined by V1-V3, and a contact force Fz with respect to the Z axis perpendicular to the substrate is given by V1+V3+V2+V4. Since it would be apparent that in the formula the three values may be readily derived from the four variables, a detailed description thereof is omitted herein for the purpose of brevity.

As mentioned above, using the wiring structure of the tactile sensor in accordance with the present invention, the total 4n input/output wires needed for the 2n tactile sensor units arranged in an n×n matrix, thereby effectively improving the degree of integration of the tactile sensor.

While the present invention has been described with reference to exemplary embodiments thereof, it will be understood by those skilled in the art that various changes in form and details may be made therein without departing from the scope of the present invention as defined by the following claims.

What is claimed is:

1. A tactile sensor, comprising:
a substrate; and
n² tactile sensor units formed on the substrate and arranged in an n×n matrix,
whereby the tactile sensor senses information of a contact force with an external object based on a tactile signal provided from each of the tactile sensor units, and
wherein said each of the tactile sensor units is a tri-axial force sensor with first to fourth piezo-resistors placed in the four directions of upper, lower, left and right sides, to sense a contact force with respect to X and Y axes in parallel with the substrate and Z axis perpendicular to the substrate, the tactile sensor including a total of 4n input/output wires that have 2n input lines connected to one side of the piezo-resistors and 2n output lines coupled with the other ends of the piezo-resistors.

2. The tactile sensor as recited in claim 1, wherein the tactile sensor units arranged in n columns are divided into two parts, and, among the tactile sensor units in a same row, one side of 2n piezo-resistors constituting the divided n/2 number of tactile sensor units are commonly coupled with one input line.

3. The tactile sensor as recited in claim 2, wherein the other sides of a first piezo-resistor constituting tactile sensor units in a kth column and a fourth piezo-resistor constituting tactile sensor units in a (n−k+1)th column are connected to one output line, the other sides of a second piezo-resistor constituting tactile sensor units in the kth column and a third piezo-resistor constituting tactile sensor units in the (n−k+1)th column are connected to another output line, the other sides of a third piezo-resistor constituting tactile sensor units in the kth column and a second piezo-resistor constituting tactile sensor units in the (n−k+1)th column are connected to still another output line, and the other sides of a fourth piezo-resistor constituting tactile sensor units in the kth column and a first piezo-resistor constituting tactile sensor units in the (n−k+1)th column are connected to yet another output line, wherein k satisfies the inequality 1≦k≦n.

4. The tactile sensor as recited in claim 1, wherein, if output signals from the first to fourth piezo-resistors are V1, V2, V3 and V4, respectively, a contact force Fx with respect to the right side direction is given by V2-V4, a contact force Fy with respect to the upper side direction is given by V1-V3, and a contact force Fz with respect to the direction perpendicular to the substrate is given by V1+V3+V2+V4.

5. The tactile sensor as recited in claim 2, wherein, if output signals from the first to fourth piezo-resistors are V1, V2, V3 and V4, respectively, a contact force Fx with respect to the right side direction is given by V2-V4, a contact force Fy with respect to the upper side direction is given by V1-V3, and a contact force Fz with respect to the direction perpendicular to the substrate is given by V1+V3+V2+V4.

6. The tactile sensor as recited in claim 3, wherein, if output signals from the first to fourth piezo-resistors are V1, V2, V3 and V4, respectively, a contact force Fx with respect to the right side direction is given by V2-V4, a contact force Fy with respect to the upper side direction is given by V1-V3, and a contact force Fz with respect to the direction perpendicular to the substrate is given by V1+V3+V2+V4.
